(19) United States
(12) Patent Application Publication
(10) Pub. No.: US 2007/0175123 A1
(43) Pub. Date: Aug. 2, 2007

(54) Trim system for doors and windows with corner block assembly

(76) Inventors: Richard Bernier, Levis (CA); Nadine Beland, Shannon (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/332,258

(22) Filed: Jan. 17, 2006

(51) Int. Cl. E06B 1/04

(52) U.S. Cl. 52/211

(57) ABSTRACT

A trim system is provided including a base and a block having complementary mating elements for being snap-fitted together. Trim of the trim system includes a mating element complementary to another mating element of the base for snap-fitting to the base. Fastening of the base to a wall material or similar surface is preferably not necessary, because the base snaps to the trim and the block snaps to the base, providing desired stability. The block, or corner block, can include alignment projections for abutting with one or more edges of the base, thereby providing self-alignment of the block or corner block. Trims may also include another mating element for snap-fitting into a frame or trim support having a complementary mating element.

### FIELD OF THE INVENTION

The present invention relates generally to trim systems for doors and windows. More particularly, the present invention relates to a trim system having a corner block assembly.

### BACKGROUND OF THE INVENTION

Trim systems for doors and windows usually include lengths of trim material disposed on the perimeter of door and window frames. The trim material can be made of, for example, wood, wood composite, poly-vinyl chloride or other materials. Such trim systems are used to enhance the appearance of doors and windows by covering the area where the frame of the door or window engages an opening in a wall. Such areas at the perimeter of the frames of doors and windows will often include unsightly gaps between the finishing material of the wall (drywall, wood, paneling, etc.) and the frame. These gaps will usually show inner wall material such as, for example, insulation, barrier material, tar paper etc. Covering such gaps thus leads to better esthetics.

Of special consideration in such trim systems, is how the corners of the doors and windows are finished. The simplest form of corner finishing is where the ends of the lengths of trim material are abutted to each other, often at a mitre joint. More elaborate corner finishing can include a corner block covering the area formed by abutting lengths of finishing materials. Traditionally, a block having portions undercut to complement the profile of the corner trim material is placed over the corner and fastened or screwed to the trim material and/or wall. The variability of the undercut portions of the block and of the profile of the corner trim material requires that great attention be paid to properly align the corner block with the lengths of trim material. Furthermore, fastening of the corner block is often impeded by lack of a sturdy wall material to which to fasten the corner block. Oftentimes, the corner block installer will find that the fastener engages nothing but insulating material and will have to reposition the corner block or try to fasten the corner block in a different manner.

Some known decorative trim assemblies for doors and windows include a corner molding assembly having a base with apertures. The base is for fastening to a building structure via the apertures and for receiving a corner block. A fastener is used to fasten the corner block to the base and a cover plate can be used to cover the area where the fastener is located. Thus, the corner molding assembly requires multiple fastening steps and the placement of a cover plate. This leads to complicated assembly and high manufacturing costs.

In another known approach, a corner casing receptacle is provided for enclosing and masking from view adjacent ends of moldings. The corner casing is held in place by adhesive, which involves dispensing adhesive in often hard to reach places. The step of fixing the corner casing with adhesive requires the exercise of care in not dispensing adhesive on the surrounding trim.

In the field of frames, a frame border connecting device is known for connecting lengths of frame border at a corner of the frame. The connecting device includes a corner base element and a corner cover for sliding on to the base and for interlocking with the base. Adapting such a device to the art of door and window trim would not be practical since the sliding of the cover over the base requires that sufficient unobstructed space be available in the trim area so as to permit the sliding of the case over the base, which is not generally the case for windows and doors.

Therefore, it is desirable to provide a corner block assembly and trim system that allow for quick assembly and self-alignment of the corner block while minimizing the use of fasteners and adhesives.

### SUMMARY OF THE INVENTION

It is an object of the present invention to obviate or mitigate at least one disadvantage of previous trim systems for doors and windows.

In a first aspect, the present invention provides a trim system for doors and windows. The trim system comprises a base having a first base mating element and a second base mating element; a block having a first block mating element complementary to, and for interlocking with, the first base mating element; and a trim having a first trim mating element complementary to, and for interlocking with, the second base mating element.

The base can include edges and the block can include at least one alignment projection for abutting to at least one edge of the base to provide self-alignment of the block with the base. The first base mating element can be for snap-fitting with the first block mating element.

The first base mating element can include a socket and the first block mating element can include a protrusion, the socket and protrusion for being snap-fitted to one another. The protrusion can be slotted and include at least one flared resilient member; and the socket can include a wall defining an opening, the opening can be for receiving the at least one flared resilient member and for interlocking the protrusion and the socket.

The trim can have a second trim mating element for interlocking with a complementary mating element of a frame. The second base mating element can be for snap-fitting with the first trim mating element. The second trim mating element can be for snap-fitting with the complementary mating element of the frame. The trim system can further include a trim support for securing to a wall surface and to interlock with the trim. In that case, the trim support can include a trim support mating element to interlock with a second trim mating element of the trim.

The block can include a side defining an opening complementary to a cross-section of the trim, the opening having an edge for abutting to the trim to provide self-alignment of the block with the trim. The base can define an aperture for receiving a fastener for fastening the base to a wall. The block can be a corner block.

In a second aspect, the present invention provides a trim system for doors and windows. The trim system includes a trim having a trim mating element. The trim system also includes a trim support for securing to a wall surface. The trim support includes a trim support mating element complementary to, and for interlocking with, the trim mating element.

In a third aspect, the present invention provides a block assembly for a trim system. The block assembly comprises a base having a base mating element; and a block having a block mating element complementary to, and for snap-fitting with, the base mating element, the block for being snap-fitted to the base element by snap-fitting the first base mating element to the first block mating element.

The base can include edges and the block can include at least one alignment projection for abutting to at least one edge of the base to provide self-alignment of the block to the base.

The base mating element can include a socket and the block mating element can include a protrusion. The protrusion can be slotted and include at least one flared resilient member; and the socket can include a wall defining an opening, the opening for receiving the at least one flared resilient member and for interlocking the protrusion and the socket. The block can be a corner block.

In an third aspect, the present invention provides a method of installing a trim system. The method comprises steps of fastening a base element to a trim; and snap-fitting a block element to the base element.

In a fourth aspect, the present invention provides a method of installing a trim system, including: fastening a base element to a trim element; and snap-fitting a block element to the base element. The method can further include snap-fitting the trim element to a frame. The method can alternatively further include snap-fitting the trim element to a trim support.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a depiction of a known trim system;

FIGS. 2A to 2C depict top and side views of a base element of an embodiment of the present invention;

FIGS. 3A to 3E depict top and side views of a corner block element of an embodiment of the present invention;

FIGS. 4A to 4E depict bottom and side views of a corner block element of an embodiment of the present invention;

FIGS. 5A and 5B depict top and cross-sectional views of a trim element of an embodiment of the present invention;

FIG. 6 is a depiction of a partial assembly of an embodiment of the present invention;

FIG. 7 is a depiction of a complete assembly of an embodiment of the present invention;

FIG. 8 is a depiction of a rear view of a corner block snap-fitted to a base element of an embodiment of the present invention;

FIG. 9 is a depiction of a partial assembly of a mitre joint of an embodiment of the present invention;

FIG. 10 is a depiction of a complete assembly of a mitre joint of the present invention;

FIG. 11 is a depiction of a trim and frame of an embodiment of the present invention;

FIG. 12 is a depiction of an assembly of the trim and frame of FIG. 11;

FIG. 13 is a depiction of a trim and a trim support of an embodiment of the present invention; and

FIG. 14 is a depiction of an assembly of an embodiment of the present invention.

### DETAILED DESCRIPTION

Generally, the present invention provides a trim system including a base and a block having complementary mating elements for being snap-fitted together. Trim of the trim system includes a mating element complementary to another mating element of the base for snap-fitting to the base. Fastening of the base to a wall material or similar surface is preferably not necessary, because the base snaps to the trim and the block snaps to the base, providing desired stability. The block, or corner block, can include alignment projections for abutting with one or more edges of the base, thereby providing self-alignment of the block or corner block. Trims may also include another mating element for snap-fitting into a frame or trim support having a complementary mating element.

The terms “snap-fit” and “snap-fitting” are terms of the art, used to describe a type of interlocking that fastens two pieces together, generally without requiring any tools. A snap-fitting interlock of two elements can allow for releasable unlocking of the two elements, though this is not always the case. The terms “snap-fit” and “snap-fitting” as used herein describe an interlocking of two elements using portions of the elements themselves, and without requiring any other tools or fasteners.

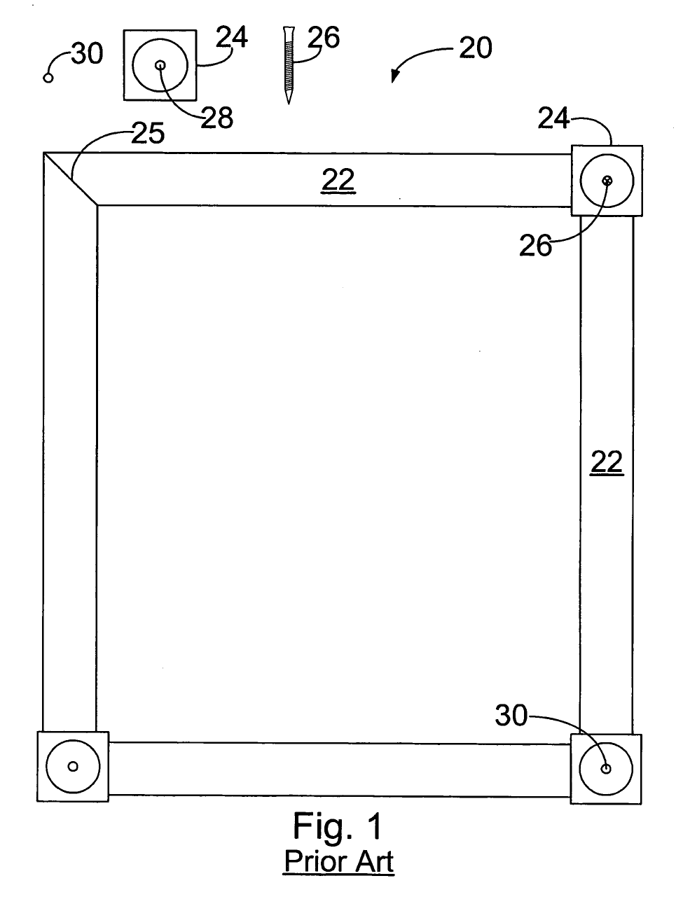

FIG. 1 depicts a known corner block and trim system 20 including trim lengths 22 forming a mitre joint 25. A corner block 24 is disposed over mitre joint 25 and secured thereon with fastener 26 through aperture 28. Alternately, an adhesive can be used to secure corner block 24 over mitre joint 25. An optional cover 30 can be placed over fastener 26 to provide better esthetics. As mentioned above, a disadvantage of this type of trim system is that a fastener 26 must be used to secure corner block 24 over mitre joint 25; also, the fastener is not guaranteed to engage a sturdy material to fasten into.

An embodiment of the present invention comprises a trim system for doors and windows, the trim system having base and corner elements interlockable to each other through complementary mating elements. The interlockability of the base and corner block elements allows for assembly of the corner block to the base without the use of fasteners. Additionally, the present invention includes a corner block with alignment projections for abutting to at least one edge of the base, thereby providing self-alignment of the block to the base.

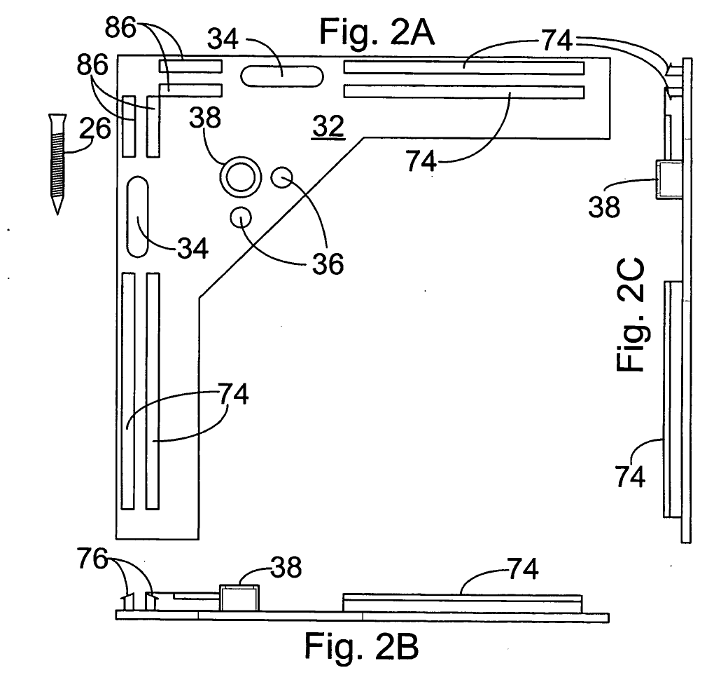

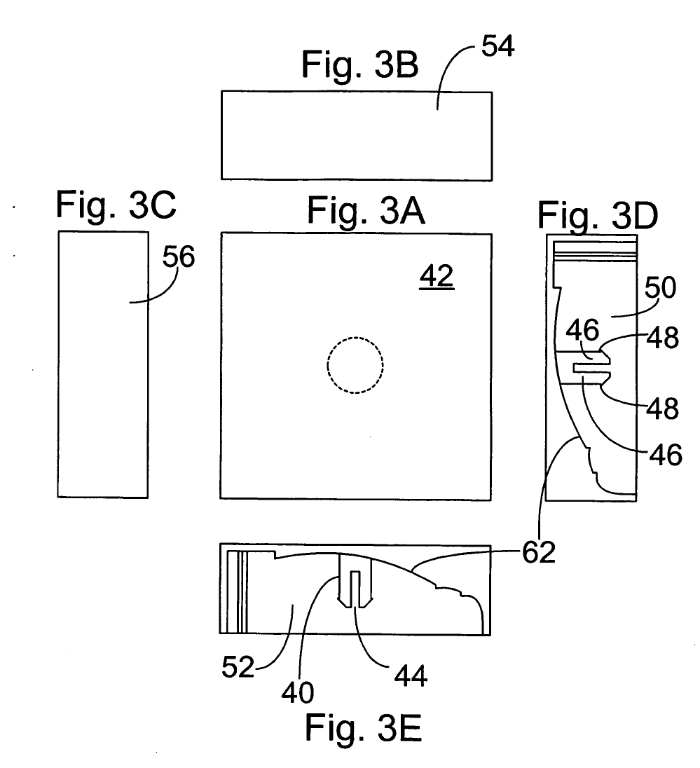

FIGS. 2A to 2C and FIGS. 3A to 3E depict respectively an embodiment of the base and corner block elements of the present invention. The term “base” as used herein is sometimes alternatively referred to in the art as a “corner key”. The term “block” as used herein is sometimes alternatively referred to in the art as a “rosette”.

In FIG. 2A, a top view of a base 32 is shown while FIGS. 2B and 2C depict side views of the base 32. In a presently preferred embodiment, the base does not need to be fastened to a wall material or similar surface. In other words, fastening of the base to the surface is preferably not necessary, because the base snaps to the trim and the block snaps to the base, providing desired stability. However, in some cases, such as when the wall is crooked, it can be advantageous as an additional support to be able to fasten the base to the wall. In such cases, the base 32 can define apertures 34 for securing the base 32 to a wall material (not shown) with fasteners 26, which can include screws, nails, rivets or any other type of fasteners known in the art. Alternately, or additionally, fasteners 26 can be used in additional apertures 36 defined in the base 32 to secure it to the wall material. The number of apertures 34 and 36 is not limited to any fixed number. The base 32 can also be secured to the wall material by other means known in the art, such means including stapling.

A socket 38 of the base 32 is for receiving a slotted protrusion 40 of corner block 42 shown in side views in FIGS. 3D and 3E. The slotted protrusion 40 preferably includes a tapered end 44 having resilient members 46 with flared sections 48. Thus, the corner block 42 can be mated to the base 32 by aligning the protrusion 40 with socket 38. By pushing the corner block 42 to force the protrusion 40 to engage the socket 38, snap-fitting the corner block 42 to the base 32 is effected.

As will be appreciated by a worker skilled in the art, the slotted protrusion 40 could be formed on base 32 and the socket 38 could be formed on corner block 42 without departing from the scope of the invention. Furthermore, the presence of a slotted protrusion or a socket are optional, as long as there are complementary interlocking mating elements of some form on the base 32 and the corner block 42.

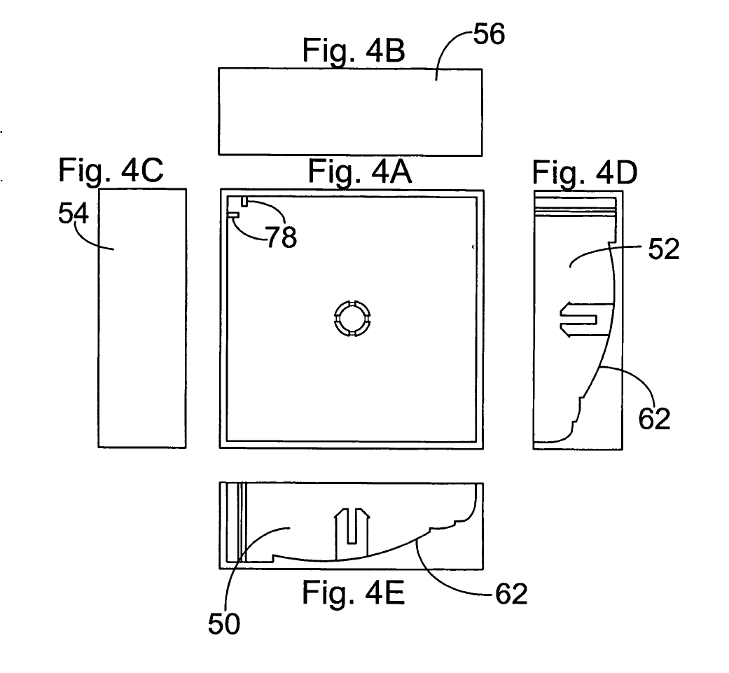

Bottom and side views of corner block 42 are shown in FIGS. 4A to 4E.

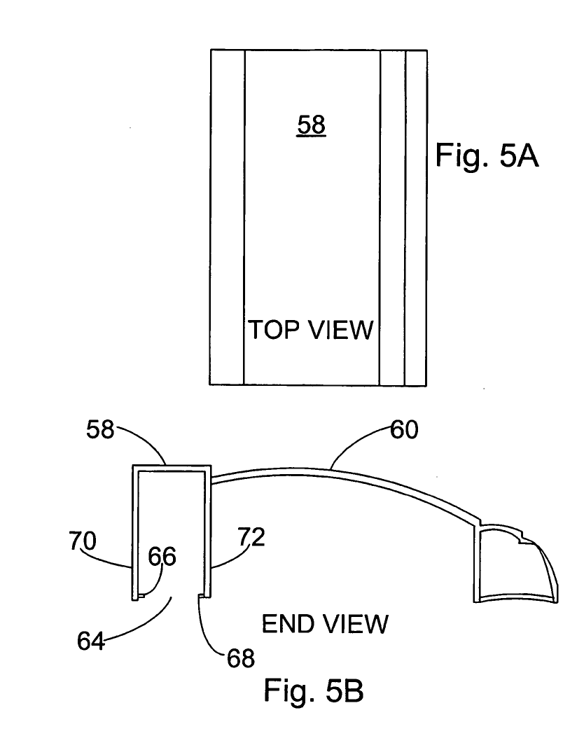

The corner block 42 shown in FIGS. 3A to 3E and 4A to 4E has two open sides 50 and 52 together with two closed sides 54 and 56. The open sides are for inter-fitting with a trim 58 shown in top and end views in FIGS. 5A and 5B respectively. It is to be noted that FIGS. 5A and 5B are not on the same scale. The profile 60 of trim 58 corresponds substantially to the profile 62 of the open sides 50 and 52. Inter-fitting open sides 50 and 52 to trims such as trim 58 allows self-alignment of the corner block 42 with the trims.

The trim 58 preferably includes a slotted wall 64 having projections 66 and 68. The side walls 70 and 72 are preferably flexible and resilient such that the trim 58 can be snap-fitted to projections 74 of base 32 shown in FIGS. 2A to 2C. The projections 74 are preferably resilient and include a tapered flared portion 76 shown in FIG. 2B for facilitating the snap-fitting of the trim 58 and the base 32. Once snap-fitted to the base 32, the trim 58 can be slid along the length of the projections 74.

As will be appreciated by a worker skilled in the art, the slotted wall 64 and projections 74 are only examples of complementary mating elements. Any type or arrangement of complementary mating elements can be used. For example, projections can be provided on the trim and a slotted wall or other type of slot can be provided on the base.

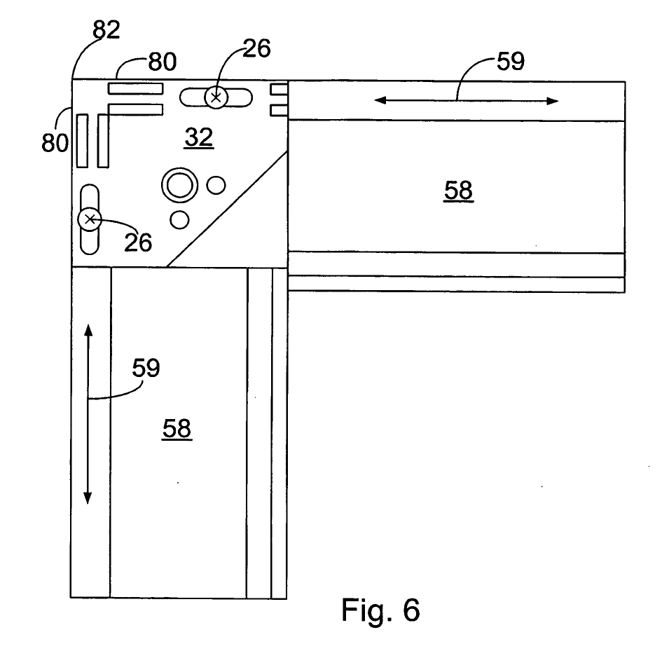

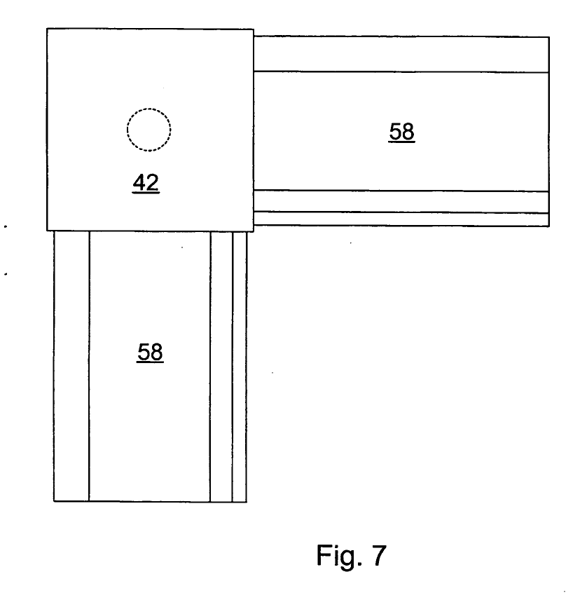

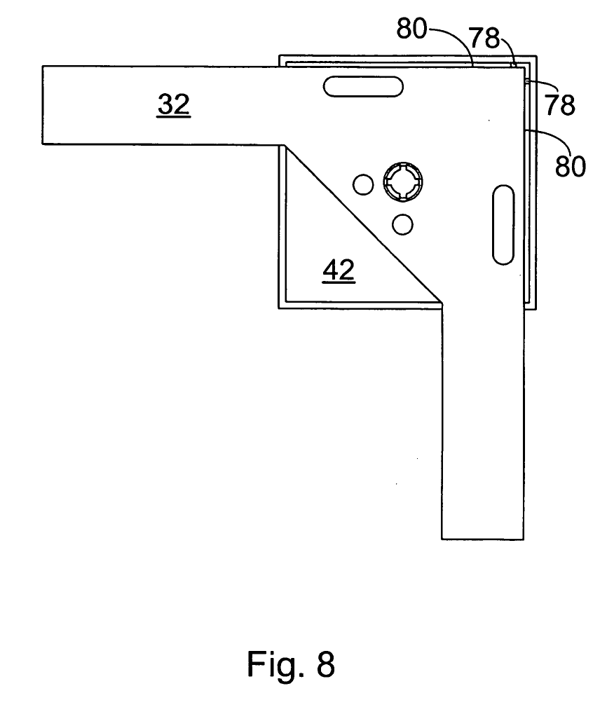

In FIG. 6, two trims 58 are shown snap-fitted to the base 32. This is an advantage over previous systems in which the base is screwed to the trim, since according to this embodiment the time and imprecision involved in screwing or fastening the base to the trim is no longer an issue. The base preferably does not require fastening to the wall material, but can optionally be secured to a wall material (not shown) by fasteners 26. The direction along which trims 58 can be slid is identified by the double ended arrows 59. After having fitted the trims 58 to the base 32, the corner block 42 can be placed over the base 32 with the slotted protrusion 40 aligned with the socket 38 and snap-fitted to the base 32 with the result shown in FIG. 7. Preferably, the alignment of the corner block 42 with the base 32 is provided by projections 78, shown in FIG. 4A, abutting the sides 80 of the base 32 in the vicinity of corner 82, shown in FIG. 6. A back view of the corner block 42 fitted to base 32, and without trims 58 in place, is shown in FIG. 8.

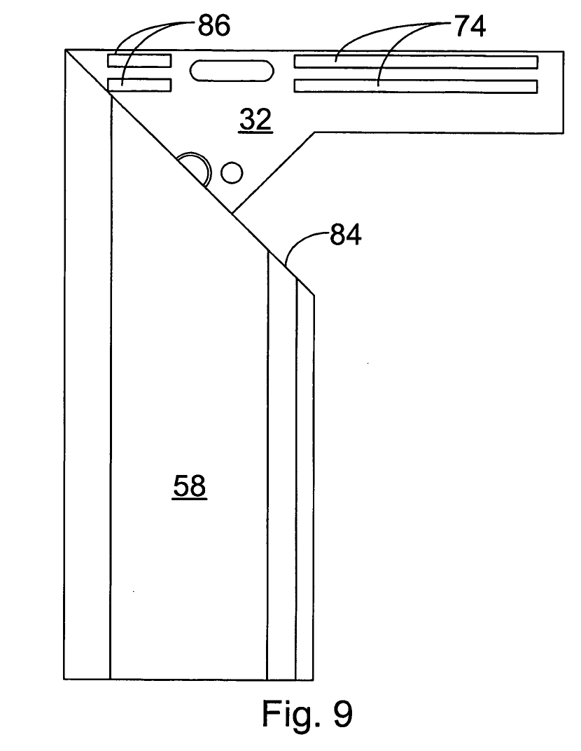

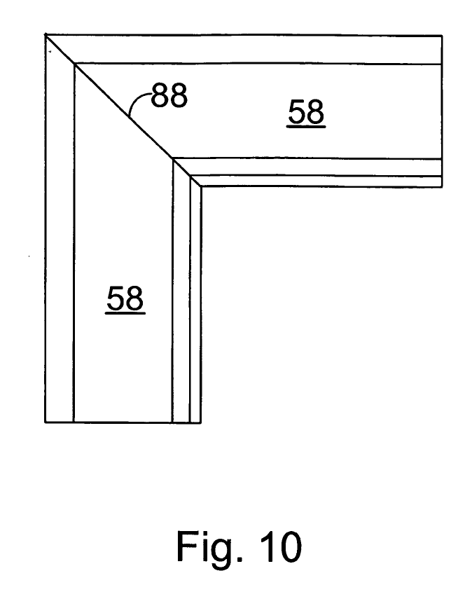

Alternately, the base 32 can allow for a mitre joint to be formed by cutting an end of the trim 58 at an angle as shown by edge 84 in FIG. 9. The mitre-cut trim 58 can be snap-fitted to the projections 74 and to the projections 86 shown in FIG. 2, which preferably have the same cross-section as the projections 74. FIG. 10 shows a mitre joint 88 formed in this way.

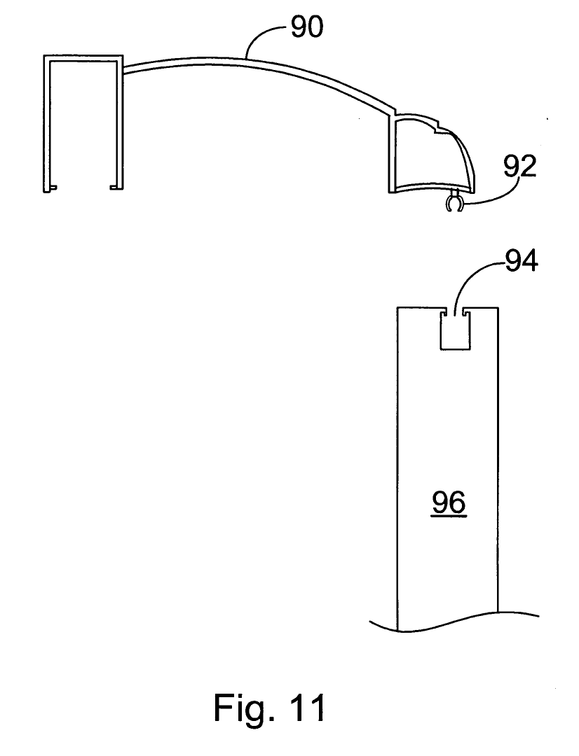

FIG. 11 shows an alternate embodiment of the trim where an end view of a trim 90 is shown having a slotted projection 92, which is for insertion in a groove 94 of a frame 96 of a door or window. Thus, the trim 90 can be snap-fitted to frame 94 in addition to being snap-fitted to the projections 74 of the base 32 in the manner described above in relation to trim 58. Thus, snap-fitting the slotted projection 92 into groove 94 causes trim 90 to be more securely attached to the perimeter of the door or window than trim 58.

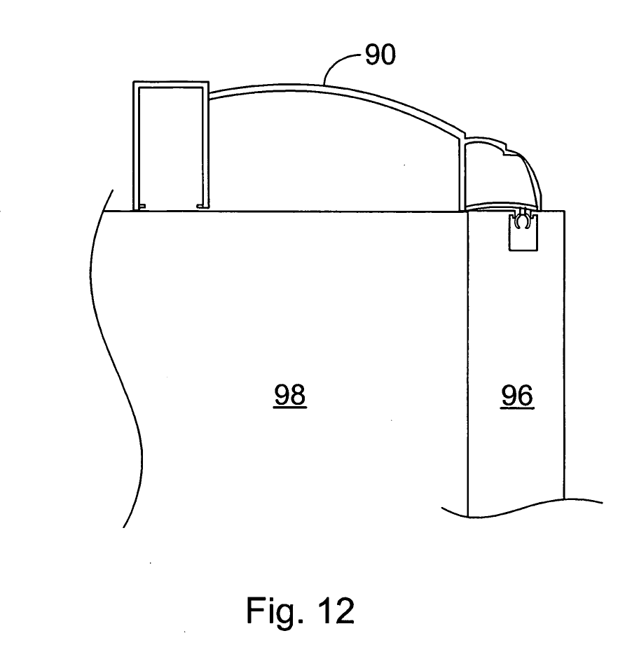

FIG. 12 shows slotted projection 92 inserted into the groove 94 with the trim 90 and the frame 96 abutting a wall 98. As mentioned previously in relation to mating elements, as long as trim 90 and frame 96 have complementary snap-fitting mating elements, it is optional that the trim 90 include a slotted projection 92 and that frame 96 include a groove 94. Alternatively, the frame can include a slotted projection, or protrusion, and the trim can include a groove.

The materials of which the base 32, the corner block 42 and the trims 58 and 90 can be made of include wood, wood composite, polyvinyl chloride (PVC), foam PVC, fibreglass, and composite materials other than wood composite.

The description of FIGS. 11 and 12 relates to a system where a trim snaps into a frame, by way of interlocking complementary elements. Exterior doors and windows inevitably have a frame. However, interior doors and interior openings (such as a “window” opening in an interior wall, with or without window material) often do not have frames. As such, since there is no frame, there is no ability to snap-fit the trim to the frame. Therefore, an alternative is desired for such cases.

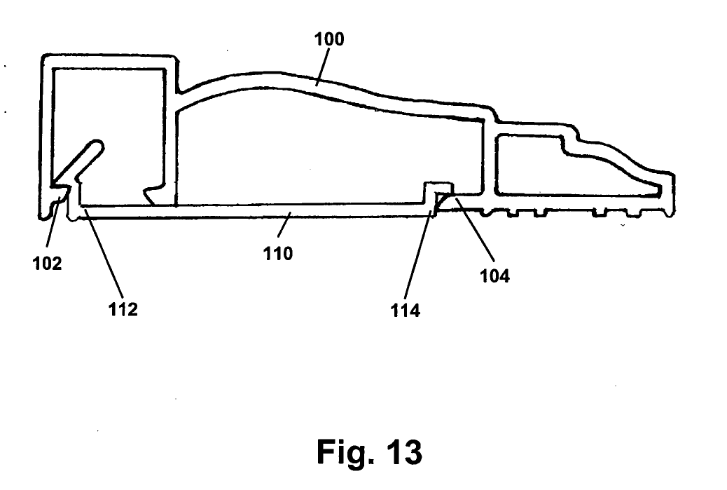

FIG. 13 shows a trim 100 and a trim support 110 of an embodiment of the present invention. The trim support 110 acts as a substitute to a frame, in situations where the opening does not have a frame. The trim support 110 can be secured or fastened, such as by stapling, directly to a wall surface. The wall surface can be a finished wall surface, such as painted drywall. The trim support 110 has a trim support mating element for mating, and preferably interlocking, with the complementary trim mating element of the trim. This provides an easy and secure way to install trim without having to worry about screwing into a stable part of a wall. In the embodiment shown in FIG. 13, the trim support 110 has two trim support mating elements 112 and 114 for interlocking with complementary trim mating elements 102 and 104.

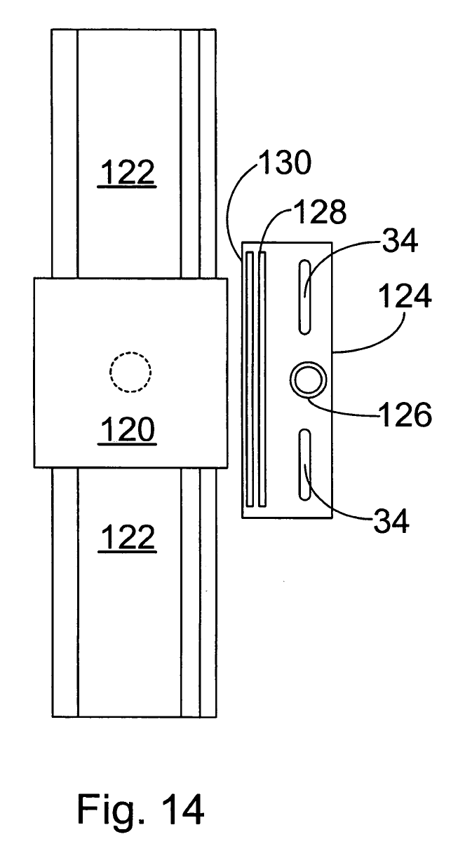

While the invention has been described in terms of a corner block, a worker skilled in the art would understand the invention to also apply to situations where blocks are used to cover adjoining trims along the perimeter of a door or windows in locations other than corners. Such a situation is shown in FIG. 14 where a block 100 covers adjoining trims 102. In this case, a base 104 having a base mating element 106 for mating to the block and a trim mating element 108 for mating to the trims is required. Alignment projections similar to projections 78 can be disposed on a same side of block 100 for abutting to, for example, an edge 110 of the base 104.

Embodiments of the present invention described above can alternatively be described as a method. As such, in an embodiment, the present invention provides a method of installing a trim system, including: fastening a base element to a trim element; and snap-fitting a block element to the base element. The method can further include snap-fitting the trim element to a frame. The method can alternatively further include snap-fitting the trim element to a trim support.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A trim system for doors and windows, the trim system comprising:
a base having a first base mating element and a second base mating element;
a block having a first block mating element complementary to, and for interlocking with, the first base mating element; and
a trim having a first trim mating element complementary to, and for interlocking with, the second base mating element.

2. The trim system of claim 1, the base including edges and the block including at least one alignment projection for abutting to at least one edge of the base to provide self-alignment of the block with the base.

3. The trim system of claim 1, wherein the first base mating element is for snap-fitting with the first block mating element.

4. The trim system of claim 3, wherein the first base mating element includes a socket and the first block mating element includes a protrusion, the socket and protrusion for being snap-fitted to one another.

5. The trim system of claim 4, wherein:
the protrusion is slotted and includes at least one flared resilient member; and
the socket includes a wall defining an opening, the opening for receiving the at least one flared resilient member and for interlocking the protrusion and the socket.

6. The trim system of claim 1, wherein the trim further comprises a second trim mating element for interlocking with a complementary mating element of a frame.

7. The trim system of claim 6, wherein the second trim mating element is for snap-fitting with the complementary mating element of the frame.

8. The trim system of claim 1 further comprising a trim support for securing to a wall surface and to interlock with the trim.

9. The trim system of claim 8, wherein the trim further comprises a second trim mating element, and the trim support comprises a trim support mating element for interlocking with the second trim mating element.

10. The trim system of claim 1, wherein the second base mating element is for snap-fitting with the first trim mating element.

11. The trim system of claim 1, wherein the block includes a side defining an opening complementary to a cross-section of the trim, the opening having an edge for abutting to the trim to provide self-alignment of the block with the trim.

12. The trim system of claim 1, wherein the base defines an aperture for receiving a fastener for fastening the base to a wall.

13. The trim system of claim 1, wherein the block is a corner block.

14. A trim system for doors and windows, the trim system comprising:
a trim having a trim mating element; and
a trim support for securing to a wall surface, the trim support including a trim support mating element complementary to, and for interlocking with, the trim mating element.

15. A block assembly for a trim system, the block assembly comprising:
a base having a base mating element; and
a block having a block mating element complementary to, and for snap-fitting with, the base mating element.

16. The block assembly of claim 15, the base including edges and the block including at least one alignment projection for abutting to at least one edge of the base to provide self-alignment of the block to the base.

17. The block assembly of claim 15, wherein the base mating element includes a socket and the block mating element includes a protrusion.

18. The block assembly of claim 17, wherein:
the protrusion is slotted and includes at least one flared resilient member; and
the socket includes a wall defining an opening, the opening for receiving the at least one flared resilient member and for interlocking the protrusion and the socket.

19. The block assembly of claim 15, wherein the block is a corner block.

20. A method of installing a trim system, the method comprising:
fastening a base element to a trim element; and
snap-fitting a block element to the base element.

21. The method of claim 20, further comprising snap-fitting the trim element to a frame.

22. The method of claim 20, further comprising snap-fitting the trim element to a trim support.
